(19) United States
(12) Patent Application Publication
(10) Pub. No.: US 2018/0284486 A1
(43) Pub. Date: Oct. 4, 2018

(54) Ophthalmic Lenses with Variable Optical Absorption Spectra Suitable for Converting the Optical Absorption Spectra of Prescription Lenses to One with an Exponential Dependence on the Wavelength over the Visible Spectrum

(71) Applicants: James M. Gallas, San Antonio, TX (US); David Salk, Berkeley, CA (US)

(72) Inventors: James M. Gallas, San Antonio, TX (US); David Salk, Berkeley, CA (US)

(21) Appl. No.: 15/935,029

(22) Filed: Mar. 25, 2018

Related U.S. Application Data
(60) Provisional application No. 62/478,029, filed on Mar. 28, 2017.

(51) Int. Cl. G02C 9/04; G02C 7/10

(52) U.S. Cl. CPC G02C 9/04; G02C 7/10

(57) ABSTRACT

An ophthalmic lens for clip-on frames is described that is tinted with a particular absorption spectrum such that when used over a tinted prescription lens, also having a specific absorption spectrum, will result in a final absorption spectrum that has an exponential dependence upon wavelength over the visible spectrum, thereby achieving the best possible preservation of color perception for the user.

### RELATED PRIORITY DATE APPLICATION

This application claims the benefit under 35 U.S.C. 119(e) of the U.S. provisional application No. 62/478,029 filed on Mar. 28, 2017.

### TECHNICAL FIELD OF THE INVENTION

The present invention relates to the field of eye ware and, more particularly to the field of eye ware products containing lenses. Still more particularly, the present invention discloses a combination of lenses, one in an eye ware frame and the other on a clip on the eye ware frame to form a desired absorption spectrum.

### BACKGROUND OF THE INVENTION

An effective way to reduce the threat from the exposure of the eye to blue light is an ophthalmic lens that filters all or a part of the HEV light. However, such a lens will appear amber or yellow in color and will therefore face widespread commercial rejection because of cosmetic disapproval, At this point in time, the optical industry is addressing the threat of blue light exposure by filtering only part of the violet light—and none of the blue part of the HEV light. The optical industry is reluctant to make prescription lenses that filter a significant portion of the blue part of the visible light spectrum because such a lens will have a noticeable tint—and worse, the tint will likely be yellow, a color retailers regard as lacking in cosmetic appeal. To a limited extent, the optical industry has some technical latitude; by filtering all of the UV and also the light between 400 and about 415 nm, it is possible to reduce significantly more glare than simply filtering only the UV part of the spectrum. At the same time, there is very little visual perception of darkness or tint in the lens because the eye has little sensitivity between 400 nm and 415 nm. Therefore, some marginal improvement in glare reduction can be attained by designing lenses that filter some of the violet light—beyond what has been done by filtering only the UV part of the spectrum—and without any significant observance of tint in the lens. However, the threat from blue light—especially with regard to the suppression of melatonin—can be achieved only if a significant part of the blue part of the spectrum is filtered by a lens. Furthermore, a significantly greater reduction in glare can be also be achieved by more extensive filtration of blue light than the industry is currently prepared to do.

A second pair of Rx lenses for the consumer market—one that is yellow in color and sufficiently-dark—is also an option but represents a niche market because Rx lenses are expensive and people are hesitant about spending a second high prices for a pair of glasses with Rx lenses; so once again, the optical industry has a reason to avoid offering an effective blue light filtering lens that provides full protection to the public.

There is therefore a dramatic conflict of interest inherent within the optical industry: on one hand, the eye care professionals and lens makers are expected to provide the best possible solutions; on the other hand the industry does not welcome disruption. An opportunity exists to design a “complimentary pair” of lenses lenses which complement the “base pair” of prescription lenses and that also provide a Melanin light spectrum for the combination of the base pair and the complimentary pair that protects from the adverse effects of the upper band of blue light on the sleep cycle, but can also provide protection in the lower band of blue light, when the base pair has no treatment (coating or monomer) to address HEV light,

There is an additional physical and neuro-physiological conflict of interest between the goal to filter blue light and the assurance of the perception of color for consumers who wear eyewear with lenses that filter blue light. Previous art (U.S. Pat. No. 8,133,414) has described the use of melanin, asphaltenes and ocular lens pigment as examples of HEV (high energy visible, violet and blue) light-filtering materials that do insure the preservation of the perception of color. In addition, the provisional application references previous art (Ser. Nos. 14/331,022 and 13,999,867) that describes light filters that have optical density spectra with an exponential curve and thereby preserve the perception of color for those people who wear the lenses that combine the base pair of lenses and the complimentary pair of lenses.

### BRIEF SUMMARY OF THE INVENTION

This invention relates to ophthalmic lenses for clip-on frames. More specifically, it relates to clip-on eyewear containing tinted lenses—called the ‘Complimentary’ pair of lenses—that contain dyes or pigments with a first selected optical density spectra; and that when these lenses are used in combination with prescription lenses—called the ‘Base’ pair of lenses—that have a second selected optical density spectra, the resulting optical density will have be an exponential curve. Applicants assert that such resultant lenses will preserve the perception of color, However, the primary feature of this invention is that it resolves an existing conflict of interest between the use of yellow or amber tinted lenses that filter blue light and therefore provide protection, glare reduction and preservation of night time production of melatonin, and overall health, with a conflicting cosmetic aversion by consumers and eyecare professionals to wear or offer to wear yellow or amber-tinted lenses. Specifically, the invention allows: a) the consumer to buy and purchase a relatively expensive pair of prescription glasses with lenses (the ‘base’ pair) that have little to no tint—and which are therefore cosmetically acceptable—but which have some minimal protection from UV, violet and some small amount of blue light filtration; and b) the consumer to purchase a relatively inexpensive pair of clip-on glasses with lenses (the ‘complimentary’ pair) that have been tinted so that they have a transmission spectrum—so designed—that when used in combination with the base pair of lenses provide a final transmission spectrum that is substantially similar to that of melanin and which also satisfy certain levels of protection from damage to the retina, and/or reduction of glare and/or reduction of light that suppresses the night time production of melatonin.

The invention allows clip-on eyewear to be placed over existing prescription eyewear and thereby significantly improve the capacity of the prescription eyewear to filter the high energy visible light in a way that increases the protection against damage to the retina, or that increases the night time protection of melatonin, or that reduces glare when the wearer is exposed to HEV light.

Another purpose of the invention is to provide the proper final transmission spectral curve by taking into account the spectral curve of the base lenses. This is a new and unique approach to providing the optimal final transmission curve, as they may be significant variations in the base pair, based upon the materials, coatings, treatments or other criteria, that may influence the selection of a clip-on lens to compliment the base pair. It is our contention that these variations can provide meaningful improvements in the performance and protection provided by the complete eyewear/clip-on combination.

Because different people may require or prefer different luminous transmission values for the combination of the Rx lens and clip-on lens of this invention as described above, it is a further objective of this invention to describe how such combination of transmission spectra will simulate the transmission spectra of the human lens at different ages wherein the luminous transmission generally decreases with age—but which all correspond to optical density values having an exponential behavior.

These and other advantages of the present invention will become apparent from the following description.

### BRIEF DESCRIPTION OF THE DRAWINGS

For a more detailed description of the preferred embodiment of the invention, reference will now be made to the accompanying drawings, wherein:

FIG. 1—Optical density, Natural logarithm of optical density and Transmission spectrum of a melanin indoor lens

FIG. 2—Transmission spectrum of Prevencia Base Pair indoor lens;

FIG. 3—Transmission spectrum of Clip Modifier Complimenting Pair of lenses for Prevencia lens.

FIG. 4—Combination Transmission spectrum of a clip-on lens of Example 1.

FIG. 5. Transmission Spectrum for the lens of Example 2.

FIG. 6. Emission Spectrum for the Light Source of Example 2

FIG. 7. Action Spectrum for Glare

### DETAILED DESCRIPTION OF THE INVENTION

### Definitions

1. Average transmission of glare-causing blue light means the average transmission of the blue light by a specific lens, where the transmission of the specific lens is weighted—wavelength by wavelength—by the emission spectrum of the light source and the action spectrum for glare.

2. Average transmission of melatonin suppressing blue light means the average transmission of the blue light by a specific lens, where the transmission of the specific lens is weighted—wavelength by wavelength—by the emission spectrum of the light source and the action spectrum for the suppression of melatonin

3. Average transmission of retina and macula-damaging blue light means the average transmission of the blue light by a specific lens, where the transmission of the specific lens is weighted—wavelength by wavelength—by the emission spectrum of the light source and the action spectrum for damage to the retina.

4. Action spectrum means a probability spectrum associated with a photochemical event that corresponds to some type of threat. This probability spectrum is also associated with a wavelength region. It provides the wavelength dependence of the probability for the threat.

5. Base Pair of Lenses means a first pair of Rx lenses. In practice, these lenses will either be clear or will have very little color and will generally be cosmetically acceptable to the wearer. The Base Pair of lenses can also be considered the primary pair of lenses in whose frames the owner will generally use during the day.

6. Complimentary Pair of Lenses means a pair of lenses that will compliment the Base Pair of lenses.

7. Combination Spectrum is the product of the transmission spectrum of the Base Pair of lenses with the transmission spectrum of the Complimentary Pair of lenses; it is also the sum of optical absorption spectra of the Base Pair of lenses and the optical absorption spectrum of the Complimentary Pair of lenses. The combination spectrum—in its optical density form—will be exponential in its functional dependence on wavelength.

8. Optical Density of a material is the logarithmic ratio of the intensity of transmitted light to the intensity of the incident light passing through the substance

### Preferred Embodiment

A preferred embodiment of this invention comprises a Base Pair of prescription lenses with a first and fixed optical absorption spectrum over the UV, visible and near infrared spectrum of wavelengths; and a clip-on frame with a Complimenting lens with a second absorption spectrum and where the second absorption spectrum is adjusted so that the sum of the two spectra—added wavelength by wavelength—is an exponential function. This resulting spectrum is called the Combination Spectrum. Alternatively, the two preceding lenses can be described by their respective transmission spectra which, when multiplied together, yields a spectrum that represents the transmission spectrum of the composite. One can then obtain the optical absorption spectrum of the composite by the familiar algorithm, OD=−logT, which again should be an exponential function because of the specific selection of the transmission spectrum of the lens of the clip-on.

While the preferred embodiment addresses the goal of combining a “base lens” color spectrum, (found in the wearer's prescription eyewear) and a clip-on filter (designed to compliment the “base color spectrum”) to achieve a Melanin Color Spectrum—or an exponential dependence on wavelength—it is possible to use this innovative strategy of engineering accessory lenses to achieve a variety of absorption spectra for other applications.

For example, there are lenses that are specifically designed to have absorption spectra that are known to minimize migraine headaches. These lenses, at present, are designed as a “one size fits all” filter, when in fact, the final color spectra of the eyewear may be better achieved by using filters that are specifically engineered to work with the base lens color spectrum, to provide a final absorption spectrum (base pair+accessory lens) that is ideal for minimizing migraines.

There are many possible uses of clip-on, or “accessory” lens filters that may be used in combination with a pair of glasses to provide relief from migraines, (example above), assist with sleep disorders, ADD, ADHD, color perception, and other various applications. In these applications, (some, but not all) it may be desirable to take into account the spectral curve of the base pair of eyeglasses and then knowing the desired FINAL spectral curve, design an accessory or clip-on lens, which provides the needed spectral curve to combine with the wearer's eyeglasses and achieve the desired final result.

### The Combination Optical Spectra

The optical density or optical absorption of the Combination spectrum should have an exponential form in its dependence on wavelength over the visible spectrum. Melanin light filters have such an exponential dependence.

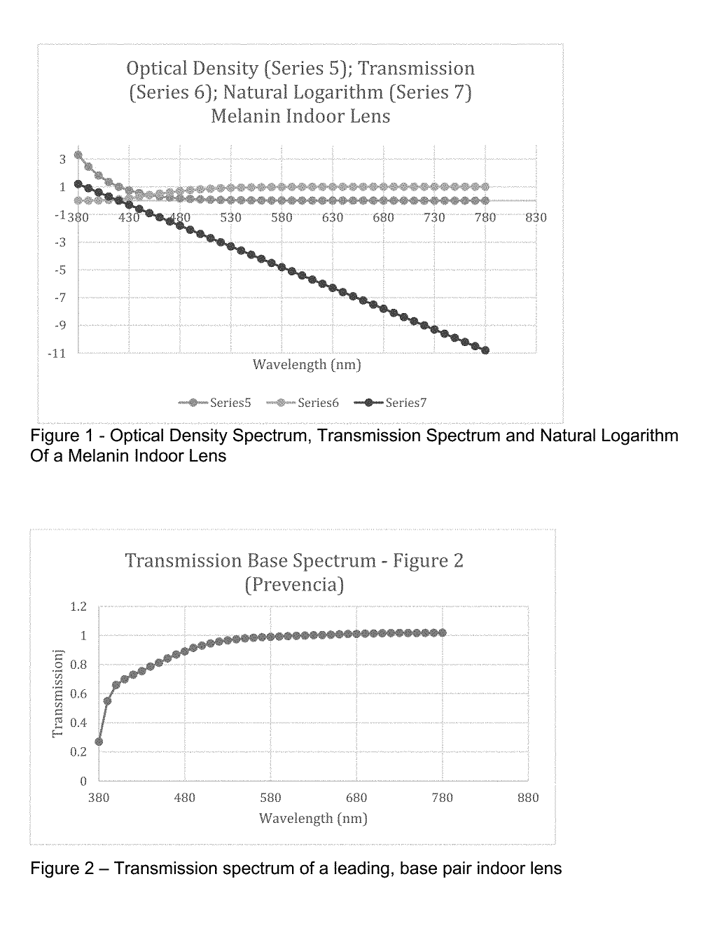

FIG. 1 shows the Optical density of a melanin indoor lens, and its natural logarithm—obtained using the equation, LnOD. The straight line of FIG. 1—with an R² of 1—confirms the exponential character of the optical density. The transmission spectrum is obtained according to the formula, T=10^{-OD}. where the equation is determined at every 10 nanometers of wavelength between 380 nm and 780 nm.

The optical absorption spectrum of melanin—because of its exponential dependence on the visible wavelengths—will serve as the prototype for the spectrum of the Combination Lens. It is noted that the natural logarithm of the Optical density will be—by definition—a straight line, and that, in this invention all slopes of such straight lines can represent the Combination spectrum. Also, the corresponding luminous transmissions associated with said straight lines can vary.

It is an essential feature of the Combination spectrum that its optical density—like melanin—has an exponential dependence upon wavelength over the visible spectrum and that lenses with melanin universally preserve the perception of color for people wearing lenses with melanin. Therefore, while the Complimentary lens of this invention allows the Base lenses to become transformed into a more highly performing Combination system—with greater reduction in glare; or greater preservation of the night time production of melatonin; or greater protection to vision against damage from blue light—it is also true that said Combination system of lenses best preserves the perception of color because optical absorption spectra with an exponential dependence ensure the preservation of the perception of color.

### EXAMPLE 1

### Determination of the Complimentary Spectrum From a Given Base Spectrum and for a Specific Combination Spectrum

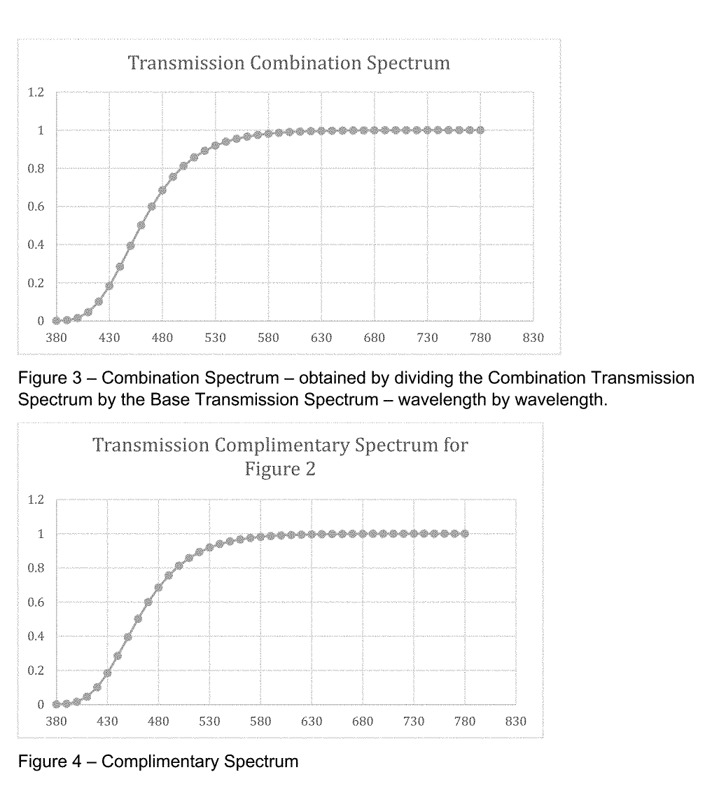

In this example, an ophthalmic prescription lens of commercial prominence is currently promoted as a lens that significantly reduces blue light and thereby reduces glare and photo-stress (need to be aggressive but careful here). The transmission spectrum (Base Transmission) of this lens is shown in FIG. 2 and at any wavelength the transmission is defined as T_{baseλ}.

In this example, the transmission spectrum of a melanin lens (the Combination Spectrum in this particular case) with a luminous transmission of 70% and suitable for indoor use is shown in FIG. 3 and at any wavelength has a transmission T_{combλ}. An essential feature of this invention is that the transmission spectrum of the clip-on lens (the Complimentary Spectrum)—with the transmission at any wavelength is given by T_{complλ} as follows:

T_{complλ}=T_{combλ}/T_{baseλ}.

And the Complimentary Spectrum is shown in FIG. 4. In order to actually make a lens with this transmission spectrum a dye will be selected—by those skilled in the art—that closely mimics this specific spectrum, or with two or more dyes that, when added together in suitable proportions, will have a spectrum that closely mimics this specific spectrum.

### Second Preferred Embodiment

A method for defining the transmission or optical absorption spectrum for a variety of melanin-like spectra that correspond to different luminous transmissions for the Combination Spectrum.

A second preferred embodiment of this invention comprises a method for defining the transmission or optical absorption spectrum for a variety of melanin-like spectra that correspond to different luminous transmissions for the Combination Spectrum. This is important in order to meet specific requirements for determining, in advance: an average transmission of glare-causing blue light; an average transmission of melatonin suppressing blue light; or an average transmission of retina and macula-damaging blue light for the Combination spectrum.

As described in U.S. patent application Ser. No. 13/999,867, the preservation of color perception is assured by selecting the transmission spectrum of a specific lens so that its optical density is an exponential function of the wavelength over the visible spectrum.

In order to do this, a luminous transmission is first selected—or equivalently the transmission at 550 nm, where the eye is most sensitive. For an indoor lens, a Preferred transmission at 550 nm should vary from about 60% (the darkest) to close to 100% (the lightest); next a plot of the natural logarithm of the optical density, LnOD is constructed as a straight line plot against the wavelength using:

LnOD_{λ}=mλ+b

Next, the OD at 550 nm is found using OD=−LogT and then LnOD at 550 nm is calculated from the value found for OD at 550 nm.

Then the pair of numbers m and λ are found by assuming a range of values for m and then using LnOD_{λ}=mλ+b to find the corresponding values for b.

Finally, the various pairs of values for m and b are used sequentially in LnOD_{λ}=mλ+b in an Excel table for example where the values for OD and finally t can be obtained as a function of wavelength (the spectral data) by using the anti logarithm for LnOD_{λ} and T=10^{-OD} at each wavelength.

In this way, a series of optical density spectra—along with their corresponding transmission spectra—can be determined, all with an exponential dependence upon the wavelength.

One of these transmission spectra will minimize the average transmission of blue-light-causing glare according to the algorithm shown in Example 2 below:

### EXAMPLE 2

### The Transmission or Optical Absorption Spectrum for a Variety of Melanin-Like Spectra That Correspond to Different Luminous Transmissions for the Combination Spectrum

In this example, the luminous transmission at 550 nm is set to be T=70%, or T=7.

Then using OD=−Log T=−log (0.7)=−(−0.1549)=0.1549

With the optical density set as an exponential function over the visible region of wavelengths, then

OD=ae^{-mλ}

### Then

InOD=Ina−mλ.

### Or,

InOD=−mλ+b

Which is the equation for a straight line for a plot of LnOD vs λ. In this example, the

ODS at 550 nm is 0.1549, so

Ln (0.1549)=−mλ+b

Or −1.865=−550 m+b. This equation represents a family of straight lines—but with different slopes—that all pass through the same point at 550 nm. Table 1 has a list of such values. Each set of values for the pair m and λ provide a transmission spectrum according to the equation,

InOD(λ)=−mλ+b

A set of these values for m and λ over a limited range are presented in Table 1.

And the Optical density and transmission spectra corresponding to the set value of T=70% at 550 nm and a specific value for the slope (m=0.025) of the straight line is used in Ln OD=mλ+b to obtain Table 2.

Third Preferred Embodiment. A third preferred embodiment of this invention (described in previous art Ser. Nos. 14/331,022 and 13,999,867) is a method for obtaining a minimum value for the weighted average transmission of glare-causing blue light, or retina-damaging blue light, or melatonin-suppressing blue light and wherein the transmission spectra associated with said minimum value for the weighted average transmission value also corresponds to an optical density have an exponential dependence upon the wavelengths over the visible spectrum,

OD=ae^{-mλ}

And this equation is equivalent to:

LnOD(λ)=mλ+b

Therefore, the spectra for OD (λ)—as well as for t(λ)—can be determined as a function of wavelength. And each of these transmission spectra for t(λ) can be used in the equation,

T_{M}=ΣS_{λ}A_{λ}t_{λ}/ΣS_{λ}A_{λ}

where S_{λ} is the emission spectrum of the light source; A_{λ} is the action spectrum for the suppression of melatonin; and where t_{λ} is the transmission spectrum of the particular lens.

In an Excel page, the preceding equation is used to determine the transmission spectra for each set of value of m and λ

### EXAMPLE 3

### Determination of the Transmission Spectrum of a Lens for a Specific Average Transmission of Melatonin Suppressing Blue Light

In this example, an indoor lens with a specific value of transmission of 70% at 550 nm (T=0.7) was assumed and the transmission spectrum of a lens for a specific average transmission of melatonin suppressing blue light of about 13% was desired.

The condition that T=0.7 at 550 nm sets the values for the pairs of m and λ.

In order to determine this transmission spectrum, the algorithm

T_{M}=ΣS_{λ}A_{λ}t_{λ}/ΣS_{λ}A_{λ}

was used, where S_{λ} is the emission spectrum of the light source; A_{λ} is the action spectrum for the suppression of melatonin; and where t_{λ} is the transmission spectrum of the particular lens. And this procedure was used to determine the values shown in Table 3. From this table, it can be seen that a value of m=0.025 gives a value for T_{M}=close to 13%.

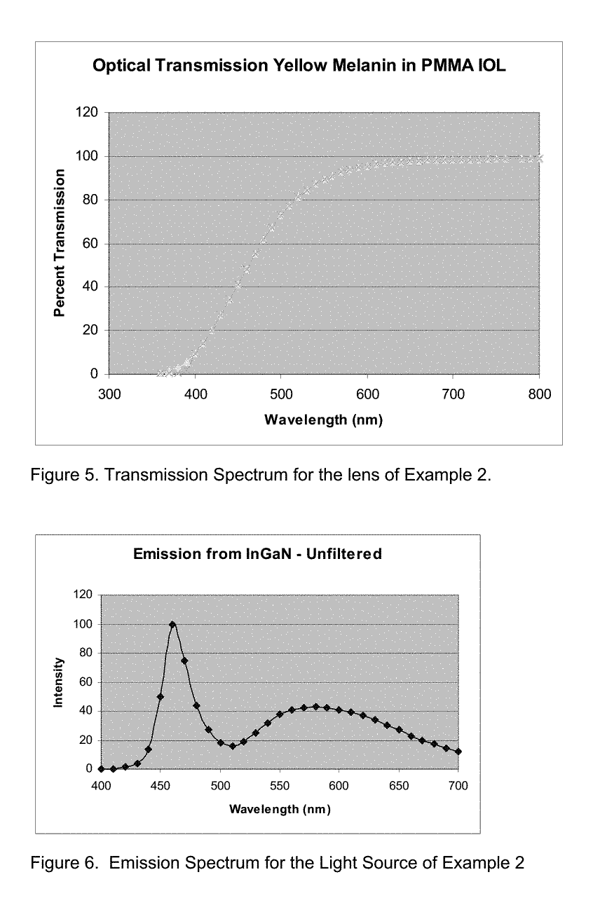

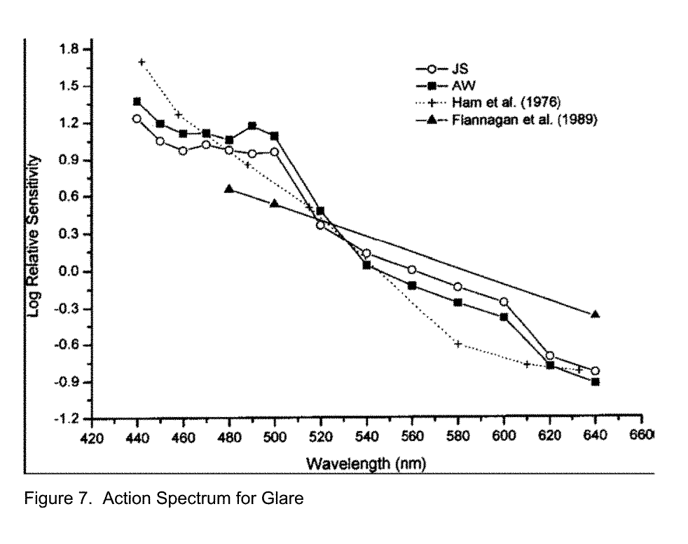

The average transmission of glare-causing blue light by a specific lens is determined in this invention by weighting the transmission spectrum of the lens (FIG. 5) by the emission spectrum of the light source (FIG. 6) and by the action spectrum for glare (FIG. 7)—according to:

T_{G}=ΣS_{λ}P_{λ}t_{λ}/ΣS_{λ}P_{λ} (1)

Here S_{λ} is the intensity of the light source at wavelength λ (for example, the iPad), P_{λ} is the glare sensitivity at wavelength λ (for example as in FIG. 1), and t_{λ} in the transmissivity of the light filter at wavelength λ. This equation is a standard representation for an average quantity weighted by its dependent factors and is readily recognized by those skilled in the art.

Thus T_{G} represents an average transmission of discomfort-causing glare by the particular lens—weighted by the spectral distribution of the light source and the wavelength dependent form of the action spectrum. For lenses with transmissions spectra that result in lower value of T_{G}, one would expect a correspondingly greater reduction in glare.

### Tables

TABLE 1
a list of values for the pair m and b in the equation LnOD = ml + b
where the transmission at 550 nm corresponding to these pairs of
values is T = m 70% or T = .7.

| | LnOD = mλ + b |
|---|---|
| Y = mx + b | T = .7 at 550 |
| m | b |
| −0.001 | −1.31433 |
| −0.002 | −0.76433 |
| −0.003 | −0.21433 |
| −0.004 | 0.33567 |
| −0.005 | 0.88567 |
| −0.006 | 1.43567 |
| −0.007 | 1.98567 |
| −0.008 | 2.53567 |
| −0.009 | 3.08567 |
| −0.01 | 3.63567 |
| −0.011 | 4.18567 |
| −0.012 | 4.73567 |
| −0.013 | 5.28567 |
| −0.014 | 5.83567 |
| −0.015 | 6.38567 |
| −0.016 | 6.93567 |
| −0.017 | 7.48567 |
| −0.018 | 8.03567 |
| −0.019 | 8.58567 |
| −0.02 | 9.13567 |
| −0.021 | 9.68567 |
| −0.022 | 10.23567 |
| −0.023 | 10.78567 |
| −0.024 | 11.33567 |
| −0.025 | 11.88567 |
| −0.026 | 12.43567 |
| −0.027 | 12.98567 |
| −0.028 | 13.53567 |
| −0.029 | 14.08567 |
| −0.03 | 14.63567 |
| −0.031 | 15.18567 |
| −0.032 | 15.73567 |
| −0.033 | 16.28567 |
| −0.034 | 16.83567 |
| −0.035 | 17.38567 |

TABLE 2
Optical density and transmission spectra corresponding to a set value
of T = 70% at 550 nm and a specific value for the slope (m = .025)
of the straight line Ln OD = mλ + b.

| | LN(O.D), | | |
|---|---|---|---|
| Lambda ▭ | m = −.025 | O.D | T |
| 400 | 1.88567 | 6.5907688 | 2.56585E−07 |
| 410 | 1.63567 | 5.1328959 | 7.36384E−06 |
| 420 | 1.38567 | 3.9975033 | 0.000100577 |
| 430 | 1.13567 | 3.1132587 | 0.000770444 |
| 440 | 0.88567 | 2.4246083 | 0.003761765 |
| 450 | 0.63567 | 1.8882869 | 0.012933413 |
| 460 | 0.38567 | 1.4705993 | 0.03383769 |
| 470 | 0.13567 | 1.1453039 | 0.071564249 |
| 480 | −0.11433 | 0.8919636 | 0.128243818 |
| 490 | −0.36433 | 0.6946619 | 0.20199382 |
| 500 | −0.61433 | 0.5410032 | 0.287737691 |
| 510 | −0.86433 | 0.4213338 | 0.379023597 |
| 520 | −1.11433 | 0.3281351 | 0.469748005 |
| 530 | −1.36433 | 0.2555518 | 0.555198343 |
| 540 | −1.61433 | 0.199024 | 0.632376945 |
| 550 | −1.86433 | 0.155 | 0.699841956 |
| 560 | −2.11433 | 0.1207141 | 0.757331218 |
| 570 | −2.36433 | 0.0940123 | 0.805355692 |
| 580 | −2.61433 | 0.0732168 | 0.844856933 |
| 590 | −2.86433 | 0.0570213 | 0.876957764 |
| 600 | −3.11433 | 0.0444083 | 0.902800413 |
| 610 | −3.36433 | 0.0345852 | 0.923453049 |
| 620 | −3.61433 | 0.026935 | 0.939864042 |
| 630 | −3.86433 | 0.020977 | 0.952846686 |
| 640 | −4.11433 | 0.0163369 | 0.963081671 |
| 650 | −4.36433 | 0.0127232 | 0.971128776 |
| 660 | −4.61433 | 0.0099088 | 0.977442413 |
| 670 | −4.86433 | 0.007717 | 0.982387897 |
| 680 | −5.11433 | 0.00601 | 0.986256769 |
| 690 | −5.36433 | 0.0046806 | 0.9892804 |
| 700 | −5.61433 | 0.0036453 | 0.991641626 |
| 710 | −5.86433 | 0.0028389 | 0.993484454 |
| 720 | −6.11433 | 0.002211 | 0.994922021 |
| 730 | −6.36433 | 0.0017219 | 0.99604304 |
| 740 | −6.61433 | 0.001341 | 0.996916966 |
| 750 | −6.86433 | 0.0010444 | 0.997598111 |
| 760 | −7.11433 | 0.0008134 | 0.998128909 |
| 770 | −7.36433 | 0.0006334 | 0.998542491 |
| 780 | −7.61433 | 0.0004933 | 0.998864708 |

TABLE 3
Weighted Average values of the transmission of melatonin-suppressing
Blue light vs slope value of the LnOD vs wavelength using
T_{M} = Σ S_{λ} A_{λ} t_{λ}/Σ S_{λ} A_{λ}
Where S_{λ} is the emission spectrum of the light source; A_{λ} is the
action spectrum for the suppression of melatonin; and where t_{λ} is
the transmission spectrum of the particular lens.

| m | Tave |
|---|---|
| 0.022 | 0.16129 |
| 0.023 | 0.149254 |
| 0.024 | 0.136986 |
| 0.025 | 0.128205 |
| 0.026 | 0.119048 |
| 0.028 | 0.105263 |
| 0.029 | 0.099404 |
| 0.03 | 0.094518 |
| 0.031 | 0.09009 |
| 0.032 | 0.086207 |
| 0.033 | 0.082645 |
| 0.034 | 0.079365 |
| 0.035 | 0.076336 |

What is claimed is:

1. An ophthalmic lens for clip-on frames comprising containing dyes or pigments with a first selected optical density spectra; and that when these lenses are used in combination with prescription lenses that have a second selected optical density spectra, the resulting optical density will have be an exponential curve.

2. An ophthalmic lens system comprising: a Base Pair of prescription lenses with a first and fixed optical absorption spectrum over the UV, visible and near infrared spectrum of wavelengths; and a clip-on frame with a Complimenting lens with a second absorption spectrum and where the second absorption spectrum is adjusted so that the sum of the two spectra—added wavelength by wavelength—is an exponential function of the wavelengths.

3. An ophthalmic lens according to claim 1 wherein the resulting optical density has a glare reduction factor of a specified value.

4. An ophthalmic lens according to claim 1 wherein the resulting optical density has a eye protection factor of a specified value.

5. An ophthalmic lens according to claim 1 wherein the resulting optical density has a melatonin production factor of a specified value.

6. An ophthalmic lens according to claim 1 wherein the frame is a wear-over type of frame.
